(19) United States
(12) Patent Application Publication
(10) Pub. No.: US 2009/0043672 A1
(43) Pub. Date: Feb. 12, 2009

(54) Methods for concluding commercial transactions online through a mediator Web site using jurisdictional information

(76) Inventor: Jean Dobe Ourega, Verdun (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 12/189,049

(22) Filed: Aug. 8, 2008

Related U.S. Application Data
(60) Provisional application No. 60/954,615, filed on Aug. 8, 2007.

(51) Int. Cl. G06Q 30/00

(52) U.S. Cl. 705/26

(57) ABSTRACT

There is provided a method for concluding a commercial transaction online through a mediator's Web site using jurisdictional information, the method comprising: disclosing on the mediator's Web site product information in connection with a product for sale, where the product is physically located within a first geographical region fixed with a first jurisdiction; receiving a request from a prospective buyer to purchase the product, where the prospective buyer is located within a second geographical region fixed with a second jurisdiction; collecting by the mediator appropriate jurisdictional information in connection with the commercial transaction; and providing the appropriated jurisdictional information to the prospective buyer before concluding the commercial transaction. There is also provided a method for controlling listing of a commercial product on a mediator's Web site, as well as a method for controlling legality of concluding a commercial transaction online through a mediator's Web site.

### FIELD OF THE INVENTION

The present invention relates generally to the field of commercial transactions, and more specifically to methods for concluding commercial transactions online through a mediator's Web site using jurisdictional information.

### BACKGROUND OF THE INVENTION

Without a doubt, the Internet has created a worldwide economy at our fingertips. International purchasers are not as common as purchases made at our local stores. However, there exist some additional fees which the local buyer will not be affected by at the point of purchase. The international buyer, however, is not so fortunate. At the point of purchase, the international buyer will automatically be subject to the import custom duty fees which will be applied to the purchased item(s). The specific costs of the import custom duty fees applied to the item(s) will depend on the importing country's item classification and description.

Therefore, traditionally, the international buyer will resort to a couple of options in order to resolve his dilemma of dealing with the issue of custom duty fees.

The first traditional option for the international buyer is to choose to utilize the brokerage services of his specific carrier. Although this choice sounds like a plausibly safe solution, there exist a few concerns. Firstly, the carrier may charge expensive fees for their brokerage services. Secondly, the buyer is placing his trust that no error will occur on the part of the carrier when determining the item classification number. This error may result in the buyer being charged a higher fee than is necessary.

The second traditional option for the international buyer is to choose to utilize an independent customs broker. A customs broker is a licensed specialist of operations and obligations pertaining to the importing country's customs laws and regulations on imports. Again, there exist a few concerns with this choice for the buyer. Firstly, as with carrier brokerage, the independent customs broker may charge expensive fees for his services which may sometimes be higher than the cost of the item(s). Secondly, there still exists the possibility of human error with the customs broker's filing of the item classification number. This error may cost the buyer a great deal of money.

Unfortunately, with the first two options, the international buyer is subjected to the whims of the carrier or the independent customs broker and is never able to exactly pre-determine the customs duty fees to be applied to his purchase.

The third traditional option for the international buyer is to choose to broker his own purchase. The buyer will need to visit his local government customs agency, perform all the due diligence in order to have his purchase released, and risk a human error in light of his inexperience in the brokerage domain.

Beside the customs duty fees, international buyers are subject to importing country regulations. Indeed, each country has its own regulations regarding importation of products. The country regulations can for instance prohibit certain types of products to be imported into the country, or can prohibit importation of products from a given country for political reasons. Also, certain types of products can be totally prohibited for use or commercialization within a country.

Traditionally, the mediator lists a list of items for sale on the mediator's Web site, and provides facilities for international buyers and sellers enabling them to conclude commercial transactions therebetween in connection with the listed items. Traditionally, the mediator has no control on the legality of concluding such transactions, and could find himself liable, either for listing a prohibited product on his server, or for enabling international buyers and sellers to conclude illegal transactions.

### SUMMARY OF THE INVENTION

In accordance with a first aspect of the invention, there is provided a method for concluding a commercial transaction online through a mediator's Web site using jurisdictional information, the method comprising:

disclosing on the mediator's Web site product information in connection with a product for sale, where the product is physically located within a first geographical region fixed with a first jurisdiction;

receiving a request from a prospective buyer to purchase the product, where the prospective buyer is located within a second geographical region fixed with a second jurisdiction;

collecting by the mediator appropriate jurisdictional information in connection with the commercial transaction; and

providing the appropriate jurisdictional information to the prospective buyer before concluding the commercial transaction.

The method preferably further comprises accepting or refusing concluding the commercial transaction by the buyer as a function of the provided appropriate jurisdictional information.

The method preferably further comprises determining by the mediator characteristics of prospective buyers authorized to purchase the product for sale, and limiting, by the mediator, the disclosing of the product information to the determined authorized prospective buyers.

The limiting the disclosing preferably comprises limiting search and view of the product information.

The characteristics preferably comprise geographical regions of the prospective buyers.

The method preferably further comprises determining, by the mediator, service fees associated with concluding the commercial transaction as a function of the characteristics of the prospective buyers.

The collecting by the mediator appropriate jurisdictional information preferably comprises:

mapping the product for sale to a unique product code;

transmitting, by the mediator, at least one of the unique product code, the first jurisdiction and the second jurisdiction to a database server comprising jurisdictional information; and

receiving from the database server the appropriate jurisdictional information.

The request is preferably carried out by the prospective buyer through the Internet using a unique IP address, and the second geographical region is determined by the mediator using the unique IP address of the prospective buyer.

The appropriate jurisdictional information preferably comprises customs duty fees associated with importation of the product into the second geographical region.

The method preferably further comprises providing to the prospective buyer an appropriate customs declaration form for submission to customs authority of the second geographical region.

The unique product code is preferably unique to a plurality of jurisdictions in accordance with an international convention.

The unique product code can also be unique to a plurality of jurisdictions in accordance with an ISO standard.

In accordance with a second aspect of the invention, there is provided a method for controlling listing of a commercial product on a mediator's Web site, the method comprising:

receiving, by the mediator, a request from a seller to list product information in connection with a product for sale, where the product is physically located within a first geographical region fixed with a first jurisdiction;

collecting by the mediator appropriate jurisdictional information; and

determining by the mediator a legal status of the listing of the product information as a function of the collected appropriate jurisdictional information.

The method preferably further comprises accepting or rejecting the request from the seller as a function of the determined legal status of the listing, the accepting or rejecting being carried out by the mediator.

The method preferably further comprises determining characteristics of prospective buyers authorized to purchase the product for sale, and limiting, by the mediator, availability of the product to the determined authorized prospective buyers.

The limiting availability preferably comprises limiting search and view of the product information.

The characteristics preferably comprise geographical regions of the prospective buyers.

The method preferably further comprises determining, by the mediator, service fees associated with the listing a potential conclusion of a commercial transaction related with the product as a function of the characteristics of the prospective buyers.

The collecting by the mediator appropriate jurisdictional information preferably comprises:

mapping the product for sale to a unique product code;

transmitting, by the mediator, at least one of the unique product code, the first jurisdiction and the second jurisdiction to a database server comprising jurisdictional information; and

receiving from the database server the appropriate jurisdictional information.

The request is preferably carried out by the seller through the Internet using a unique IP address, and the first geographical region is determined by the mediator using the unique IP address of the seller.

The appropriate jurisdictional information preferably comprises information indicating if the product is authorized for a commercial use in accordance with the first jurisdiction.

The appropriate jurisdictional information preferably comprises information indicating if the product is authorized for exportation from the first geographical region in accordance with the first jurisdiction.

The mediator's Web site can be stored in a mediator server located in a second geographical region fixed with a second jurisdiction, and the appropriate jurisdictional information preferably comprises information indicating if the product is prohibited in accordance with the second jurisdiction.

The unique product code is preferably unique to a plurality of jurisdictions in accordance with an international convention.

The unique product code can also be unique to a plurality of jurisdictions in accordance with an ISO standard.

In accordance with a further aspect of the invention, there is provided a method for controlling legality of concluding a commercial transaction online through a mediator's Web site, the method comprising:

disclosing on the mediator's Web site product information in connection with a product for sale, where the product is physically located within a first geographical region fixed with a first jurisdiction;

receiving a request from a prospective buyer to purchase the product, where the prospective buyer is located within a second geographical region fixed with a second jurisdiction;

collecting by the mediator appropriate jurisdictional information in connection with the commercial transaction; and

determining by the mediator a legal status of the commercial transaction as a function of the appropriate jurisdictional information;

The method preferably further comprises concluding or refusing to conclude the transaction by the mediator as a function of the determined legal status of the commercial transaction.

The method preferably further comprises determining characteristics of prospective buyers authorized to purchase the product for sale, and limiting, by the mediator, the disclosing of the product information to the determined authorized prospective buyers.

The limiting the disclosing preferably comprises limiting search and view of the product information.

The characteristics preferably comprise geographical regions of the prospective buyers.

The method preferably further comprises determining, by the mediator, service fees associated with the transaction as a function of the characteristics of the prospective buyers.

The collecting by the mediator appropriate jurisdiction information preferably comprises:

mapping the product for sale to a unique product code;

transmitting, by the mediator, at least one of the unique product code, the first jurisdiction and the second jurisdiction to a database server comprising jurisdictional information; and

receiving from the database server the appropriate jurisdictional information.

The request is preferably carried out by the prospective buyer through the Internet using a unique IP address, and the second geographical region is preferably determined by the mediator using the unique IP address of the prospective buyer.

The appropriate jurisdictional information preferably comprises information indicating if the product is authorized for a commercial use in accordance with the first jurisdiction.

The appropriate jurisdictional information preferably comprises information indicating if the product is authorized for exportation from the first geographical region in accordance with the first jurisdiction.

The appropriate jurisdictional information preferably comprises information indicating if the product is authorized for importation into the second geographical region from the first geographical region in accordance with at least one of the first jurisdiction and the second jurisdiction.

The unique product code is preferably unique to a plurality of jurisdictions in accordance with an international convention.

The unique product code can also be unique to a plurality of jurisdictions in accordance with an ISO standard.

### BRIEF DESCRIPTION OF THE DRAWINGS

Further features and advantages of the present invention will become apparent from the following detailed description, taken in combination with the appended drawings, in which:

FIG. 1 is a flow chart diagram showing an embodiment of a method for concluding a commercial transaction online through a mediator's Web site using jurisdictional information;

FIG. 2 is a flow chart diagram showing an embodiment of a method for controlling listing of a commercial product on a mediator's Web site,

FIG. 3 is a flow chart diagram showing an embodiment of a method for controlling legality of concluding a commercial transaction online through a mediator's Web site;

FIG. 4 is a bloc diagram showing an embodiment of how various users interact to get appropriate jurisdictional information via a database server storing jurisdictional information; and

FIG. 5 is a bloc diagram showing an embodiment of how the various users communicate using corresponding processing devices.

### DETAILED DESCRIPTION OF THE INVENTION

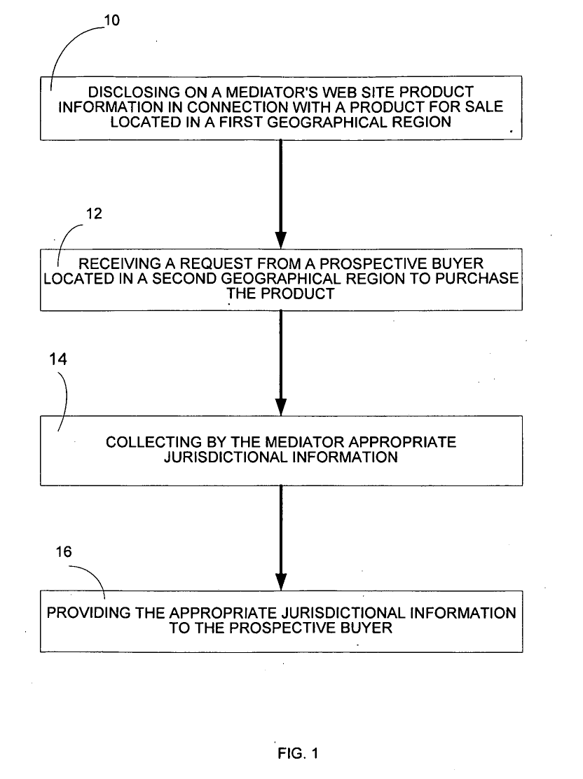

Referring to FIG. 1, there is provided a method for concluding a commercial transaction online through a mediator's Web site using jurisdictional information.

First, there is posted on a mediator's web site product information in connection with a product for sale located in a first country fixed with a first jurisdiction 10. The posting process can be carried out by the seller, but can also be carried out by the mediator after having received a request from the seller in that regard.

The posting is preferably carried out remotely through the Internet. But, it should be understood from the scope of the present invention that it can also be carried out through any communication network. Once the product information is posted on the mediator's Web site, the information is disclosed to the public by the mediator and international prospective buyers located in various countries fixed with a second jurisdiction can transmit their requests to purchase the product. The request is preferably transmitted through Internet, but it can also be transmitted through any communication network.

The mediator receives the request from an international prospective buyer, preferably through the mediator's Web site 12. Thereafter, the mediator proceeds to collect jurisdictional information in connection with the product to purchase 14 from a database server containing jurisdictional information (hereinafter “ITEMQUOTE server”).

The collection of the information is preferably carried out automatically by a computer program stored on a mediator's server. Before carrying out the collecting operation, the product is preferably mapped to a unique product code according to an international classification standard, such as ISO standard. The mapping operation can be carried out by the mediator, the seller, or any other authorized user.

The collecting process preferably consists of transmitting, by the mediator, the unique product code, the first jurisdiction associated with the seller's country and the second jurisdiction associated with the prospective buyer's country to ITEMQUOTE server, and then, after processing the information by the server, receiving thereof appropriate jurisdictional information associated with the product to purchase.

The jurisdictional information can include for instance customs duty fees associated with the importing country, and jurisdictional information indicating if the product to purchase is prohibited in the seller's country or in the prospective buyer's country. The jurisdictional information can also indicate if it there is a prohibition to import such a product from the seller's country into the prospective buyer's country, and if there are any conditions imposed by the importing country associated with the importation of such a product.

The mediator then proceeds to provide the collected appropriate jurisdictional information to the international prospective buyer, enabling the latter to take a purchase decision based thereon 16. The prospective international buyer accepts or refuses to proceed in completing the purchase transaction based on the provided appropriate jurisdictional information.

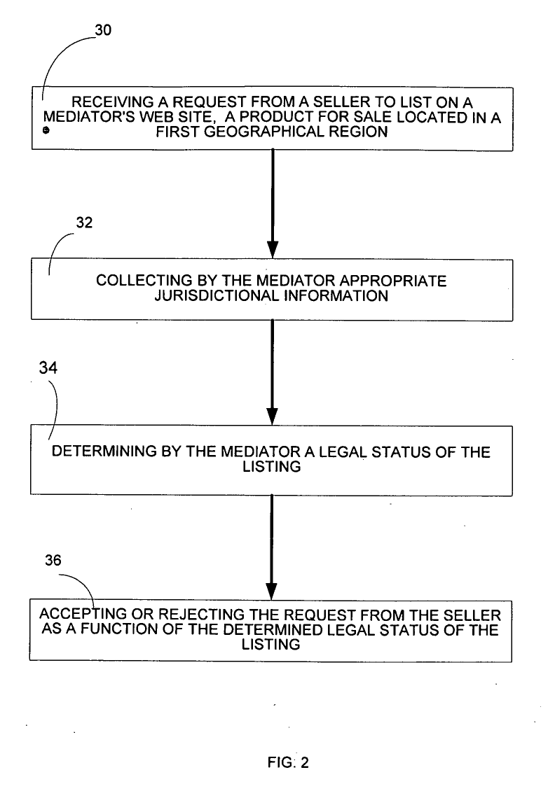

Referring to FIG. 2, there is provided a method for controlling listing of a commercial product on a mediator's Web site.

The mediator receives a request from a seller to post, on the mediator's Web site, a product for sale located in a first country (seller's country for example) 30. The mediator Web site is stored in a mediator's server located in a second country fixed with a second jurisdiction.

The mediator proceeds to collect jurisdictional information in connection with the product to post 32. The collecting process preferably starts by transmitting, by the mediator, the unique product code, the first jurisdiction and the jurisdiction to the ITEMQUOTE server. Then, after processing the information by the ITEMQUOTE server, the mediator receives thereof appropriate jurisdictional information associated with the product to post. The jurisdictional information indicates if the product to post is prohibited in accordance with any of the first and second jurisdictions. On light of the collected jurisdictional information, the mediator determines the legal status of listing the product on its Web site 34 and accepts or rejects the request as a function of the determined legal status 36.

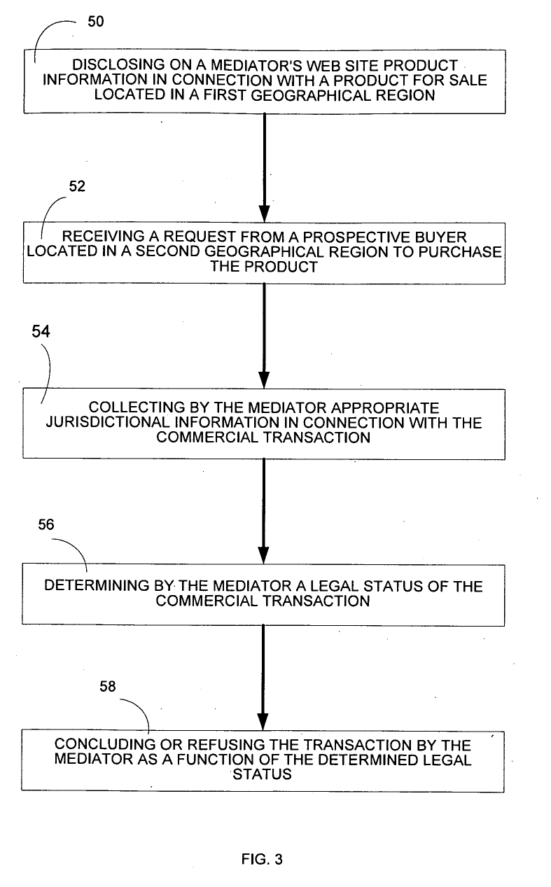

Referring to FIG. 3, there is provided a method for controlling legality of concluding a commercial transaction online through a mediator's Web site.

First, once a product for sale is posted successfully on the mediator's Web site, the mediator discloses on its Web site product information in connection with the product for sale, where the product is located in a first country fixed with a first jurisdiction 50.

The posting process can be carried out by the seller, but can also be carried out by the mediator after having received a request in that regard. The posting can be carried out remotely through the Internet or any communication network. Once the product information is disclosed on the mediator's Web site, the information becomes available to the public and international prospective buyers located in various countries fixed with a second jurisdiction can transmit a request to purchase the product. The product information can also be available and visible only to certain prospective buyers having certain characteristics, for instance, buyers located in certain geographical regions and fixed with certain jurisdictions. The request is preferably transmitted through the Internet, but it can also be transmitted through any communication network.

The mediator receives the request from the international prospective buyer, preferably through the mediator's Web site 52. Thereafter, the mediator proceeds to collect jurisdictional information in connection with the product to purchase 54.

The collection of the information is preferably carried out automatically by a computer program stored on a mediator's server. Before carrying out the collecting operation, the product is preferably mapped to a unique product code according to an international classification standard, such as ISO standard. The mapping operation can be carried out by the mediator, the seller, or any other authorized user.

The collecting process preferably consists of transmitting, by the mediator, the unique product code, the first jurisdiction and the second jurisdiction to a database server comprising jurisdictional information, and then, after processing the information by the server, receiving thereof appropriate jurisdictional information associated with the product to purchase.

The jurisdictional information can include for instance information indicating if the product to purchase is prohibited in the original country (seller's country) or in the destination country (buyer's country). The jurisdictional information can also indicate if it is possible to import such a product from the original country into the destination country.

On light of the collected jurisdictional information, the mediator determines the legal status of the commercial transaction 56 and accepts or refuses to conclude the commercial transaction as a function of the determined legal status of the commercial transaction 58.

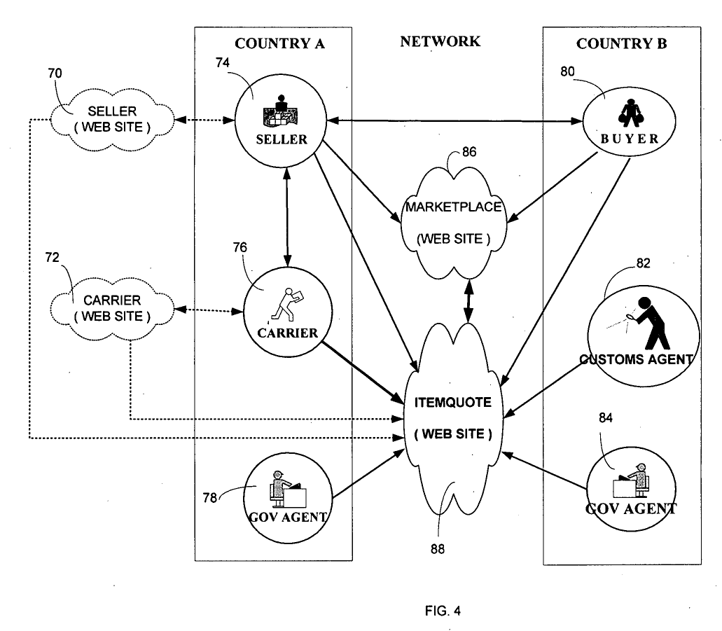

As showed in FIG. 4, the database server 88 containing jurisdictional information (ITEMQUOTE server) would allow various users to get appropriate jurisdictional information regarding a particular item. In fact, all of the seller 74, the prospective buyer 80, and the prospective carrier 76 can have a direct access to the ITEMQUOTE server 88 to get jurisdictional information about a given product. Since the ITEMQUOTE server 88 is preferably connected to the Internet, the seller 74 and the carrier 76 can access the ITEMQUOTE Web site 88 through their respective Web sites 70 and 72.

The customs authority of any country in the world can also access the ITEMQUOTE server 88 to store their respective jurisdictional information. In the example provided in FIG. 4, the government agent of the seller's country 78 and the government agent of the buyer's country 84 access the ITEMQUOTE server 88 to store and edit jurisdiction information related thereto.

When a product is disclosed on the mediator's Web site, the mediator access the ITEMQUOTE server 88 and requests jurisdictional information about the product to purchase before the conclusion of the commercial transaction between the buyer 80 and the seller 74. The mediator discloses the information to the buyer 80 to enable him to assess whether the purchase of the given product is worthwhile on light of the jurisdictional information collected. For instance, the importation of the product in the buyer's country can be prohibited or the customs fees could be too high for the buyer.

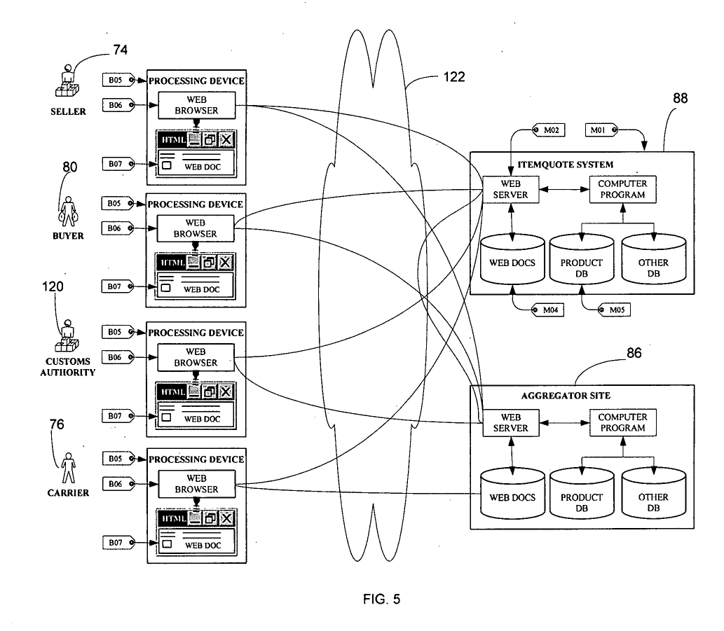

Referring to FIG. 5, there is shown how each of the seller 74, the buyer 80, and the carrier 76 communicates with the ITEMQUOTE server 88, and the aggregator site (mediator's server) 86.

It will be appreciated that each of the seller 74, the buyer 80, the carrier 76 and the customs authority 120 communicates using a corresponding processing device. Each corresponding processing device is operatively connected to a data network 122.

Each of the ITEMQUOTE system 88, the aggregator site 86 is operatively connected to the data network 30

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A method for concluding a commercial transaction online through a mediator's Web site using jurisdictional information, the method comprising:
disclosing on said mediator's Web site product information in connection with a product for sale, where said product is physically located within a first geographical region fixed with a first jurisdiction;
receiving a request from a prospective buyer to purchase said product, where said prospective buyer is located within a second geographical region fixed with a second jurisdiction;
collecting by said mediator jurisdictional information appropriate for said commercial transaction, where said jurisdictional information is associated with at least one of said first jurisdiction and said second jurisdiction;
providing said appropriate jurisdictional information to said prospective buyer before concluding said commercial transaction.

2. The method as claimed in claim 1, wherein said collecting by said mediator appropriate jurisdictional information comprises:
If required, mapping said product for sale to a unique product code;
transmitting, by said mediator, an inquiring request for inquiring a database server comprising jurisdictional information in accordance with a plurality of jurisdictions, where said inquiring request comprises at least one of said unique product code, said first jurisdiction and said second jurisdiction; and
receiving from said database server said appropriate jurisdictional information.

3. The method as claimed in claim 2, further comprising using by said mediator said collected jurisdictional information for determining characteristics of prospective buyers authorized to purchase said product for sale, and limiting said disclosing of said product information to said determined authorized prospective buyers.

4. The method as claimed in claim 3, wherein said collected jurisdictional information comprises customs duty fees required for importing said product into said second geographical region.

5. The method as claimed in claim 4, wherein said limiting said disclosing comprises limiting search and view of said product information.

6. The method as claimed in claim 5, further comprising determining, by said mediator, service fees associated with said commercial transaction as a function of said characteristics of said prospective buyers.

7. A method for controlling listing of a commercial product on a mediator's Web site, the method comprising:
receiving, by said mediator, a request from a seller to list product information in connection with a product for sale, where said product is physically located within a first geographical region fixed with a first jurisdiction;
collecting by said mediator appropriate jurisdictional information associated with said first jurisdiction; and
determining by said mediator a legal status of said listing of said product information as a function of said collected appropriate jurisdictional information.

8. The method as claimed in claim 7, further comprising accepting or rejecting by said mediator said request from said seller as a function of said determined legal status of said listing.

9. The method as claimed in claim 8, wherein said collecting by said mediator appropriate jurisdictional information comprises:
If required, mapping said product for sale to a unique product code;
transmitting, by said mediator, an inquiring request for inquiring a database server comprising jurisdictional information in accordance with a plurality of jurisdictions, where said inquiring request comprises at least one of said unique product code and said first jurisdiction; and
receiving from said database server said appropriate jurisdictional information.

10. The method as claimed in claim 9, further comprising, if said request for listing is accepted, using said jurisdictional information for determining characteristics of prospective buyers authorized to purchase said product for sale, and limiting, by said mediator, availability of said product to said determined authorized prospective buyers.

11. The method as claimed in claim 10, wherein said limiting availability comprises limiting search and view of said product information.

12. The method as claimed in claim 10, wherein said characteristics comprise geographical regions where said prospective buyers are physically located.

13. The method as claimed in claim 12 wherein said collected jurisdictional information comprises at least one of an indication if said product is authorized for a commercial use in accordance with said first jurisdiction and an indication if said product is authorized for exportation from said first geographical region in accordance with said first jurisdiction.

14. The method as claimed in claim 13 wherein said mediator's Web site is stored in a mediator server located in a second geographical region fixed with a second jurisdiction, and said appropriate jurisdictional information comprises information indicating if said product is prohibited in accordance with said second jurisdiction.

15. A method for controlling legality of concluding a commercial transaction online through a mediator's Web site, the method comprising:
disclosing on said mediator's Web site product information in connection with a product for sale, where said product is physically located within a first geographical region fixed with a first jurisdiction;
receiving a request from a prospective buyer to purchase said product, where said prospective buyer is located within a second geographical region fixed with a second jurisdiction;
collecting by said mediator jurisdictional information appropriate for said commercial transaction, where said jurisdictional information is associated with at least one of said first jurisdiction and said second jurisdiction; and
determining by said mediator a legal status of said commercial transaction as a function of said appropriate jurisdictional information;

16. The method as claimed in claim 15, further comprising concluding or refusing to conclude said transaction by said mediator as a function of said determined legal status of said commercial transaction.

17. The method as claimed in claim 16, wherein said collecting by said mediator appropriate jurisdiction information comprises:
If required, mapping said product for sale to a unique product code;
transmitting, by said mediator, an inquiring request for inquiring a database server comprising jurisdictional information in accordance with a plurality of jurisdictions, where said inquiring request comprises at least one of said unique product code, said first jurisdiction and said second jurisdiction; and
receiving from said database server said appropriate jurisdictional information.

18. The method as claimed in claim 17, wherein said request is carried out by said prospective buyer through the Internet using a unique IP address, and said second geographical region is determined by said mediator using said unique IP address of said prospective buyer.

19. The method as claimed in claim 18 wherein said appropriate jurisdictional information comprises at least one of an indication if said product is authorized for a commercial use in accordance with said first jurisdiction, an indication if said product is authorized for exportation from said first geographical region in accordance with said first jurisdiction, and an indication if said product is authorized for importation into said second geographical region from said first geographical region in accordance with at least one of said first jurisdiction and said second jurisdiction.
